(19) United States
(12) Patent Application Publication
(10) Pub. No.: US 2022/0189710 A1
(43) Pub. Date: Jun. 16, 2022

(54) UNITIZED THREE PHASE SWITCH WITH A POWER ACTUATED TRANSFORMABLE BASE AND METHOD FOR OPERATION

(71) Applicant: CLEAVELAND/PRICE INC., Trafford, PA (US)

(72) Inventor: PETER M. KOWALIK, TRAFFORD, PA (US)

(73) Assignee: CLEAVELAND/PRICE INC., TRAFFORD, PA (US)

(21) Appl. No.: 17/462,793

(22) Filed: Aug. 31, 2021

Related U.S. Application Data
(60) Provisional application No. 63/126,136, filed on Dec. 16, 2020.

(51) Int. Cl. H01H 3/32; H01H 9/02; H01H 11/00

(52) U.S. Cl. CPC H01H 3/32; H01H 11/00; H01H 9/02

(57) ABSTRACT

Switch gear for interconnecting a plurality of power transmission lines including a number of high voltage switches arranged in three phase unitized relationship for routing power. The switches are each pre-mounted on a transverse beam which is operatively attached between two oppositely disposed longitudinal parallel beams forming a unitized switch assembly with a common base structure with a transformable parallelogram outer perimeter which may be attached in the field to a support structure. The outer perimeter of the common base structure of the unitized assembly transformable common base can be transformed with a power actuator from a rectangular configuration to a rhomboid configuration that permits the width of the unitized assembly to be reduced so that the assembly can be transported by truck to an installation site and then the switch assembly may be transformed back to the rectangular configuration with the final width for installation at the site.

### CROSS-REFERENCE TO RELATED APPLICATION

This application claims the benefit of U.S. Provisional Patent Application No. 63/126,136 filed Dec. 16, 2020, which is incorporated herein by reference in its entirety.

### BACKGROUND OF THE INVENTION

The invention relates to a three phase high voltage disconnect switch for electrical switchgear, such as air break disconnect switches, used in transmission and substation systems for the control and routing of power. And, in particular, to such a three phase high voltage main disconnect switch including three individual high voltage disconnect switch pole units mounted transversely on a rectangular switch frame common base to form a three phase unitized high voltage disconnect switch for quick on-site installation. Each of the individual high voltage disconnect switch pole units have one or two blades per phase. Each of the switch blades in the operative position operate to open and close the respective high voltage air break disconnect switch.

Such a three phase switch is often referred to as a unitized gang-operated three phase switch, which is characterized by the individual pole units being pre-mounted in a gang-operated array on a switch frame common base for installation at a job site. The common base includes an attached drive linkage for operation of the gang-operated individual switch pole units. The gang-operated drive linkage is connected operationally to each of the three single phase high voltage switch pole units for imparting a force for opening and closing each of the pole units in unison. High voltage non-unitized air break disconnect switches normally require a lot of assembly effort, to be mounted in a three phase installation after reaching their final destination. For example, the individual switch pole units, i.e., single phase switches, of a three-pole switch assembly that is not unitized must each be separately mounted to the utility's structure, and then an operating linkage is added that allows all individual pole units which each include a rotating insulator to move together at the same time, speed and distance. On-site assembly of such a three-pole switch comprising separately installed individual single phase switches often results in varying and often undesirable outcomes depending on the skill level of the assemblers. The necessary skill level of installers at a job-site to ensure proper assembly is becoming more and more difficult to find, causing more of such switch assemblies that are completely assembled on-site to be set up poorly resulting in poor operation. This results in unnecessary maintenance costs to correct problems with poorly assembled switches. The present invention is directed to such unitized gang-operated three phase switches, particularly, having three switch pole units of the type mounted to a switch frame common base structural platform having a rectangular configuration. Each of the individual switch pole units includes a plurality of insulators mounted on a rigid linear transverse beam. Such a switch frame common base includes two parallel longer longitudinal beams of equal length positioned in supportive relationship underneath two shorter outer parallel transverse beams of equal length. The two outer parallel transverse beams are attached at their ends to the underlying parallel longitudinal beams forming the rectangular switch frame common base.

Building and assembling such a unitized gang-operated three-pole switch assembly having such a rectangular switch frame common base in a factory setting with highly trained workers provides a solution to the skill level problem. Assembly in the factory actually goes faster than assembly in the field due to no concern about weather or other extraneous conditions. The problem with assembling in the factory is that the unitized switch with a rectangular switch frame common base is now often too wide to ship by truck on U.S. roads, depending on the voltage rating of the switch. A Wide Load Permit and associated follow car is often required for transporting the completed unitized three phase switch by truck. Such wide truckloads are expensive for interstate travel and inconvenient due to restrictions allowing for daytime only travel. Also, there are often prohibitions regarding travel on certain days and weekends.

Such a prior art unitized gang-operated three phase high voltage disconnect switch having a rectangular switch frame common base is disclosed in Cleaveland/Price Inc. Bulletin DB-680A15, entitled “Unitized ‘Quick Install’ Switches for Substation Applications”, for example. Such a unitized three phase switch, for example, rated at 138 kV volts or higher, with a standard rectangular common base configuration, is oversized and too wide in the final assembled state to ship legally by truck on roads in the U.S. without special permits.

Another type of mounting arrangement, for a unitized gang-operated three phase high voltage switch assembly is known in the art. This other type of mounting arrangement utilizes an elongated single base member for mounting the plurality of switch pole units instead of the rectangular switch frame common base configuration. U.S. Pat. No. 9,355,797 B1 issued to Charles M. Cleaveland, and others, on May 31, 2016, and assigned to the present assignee, Cleaveland/Price Inc. of Trafford, Pa., discloses such an elongated single base member type mounting arrangement. The said U.S. Pat. No. 9,355,797 B1 is herein incorporated by reference as though fully set forth. In this regard, currently being marketed by Cleaveland/Price Inc. is a one-way unitized gang-operated phase over phase switch disconnect assembly that is mounted to an elongated single base member which can be mounted vertically to a utility pole; reference is made to the present assignee's, Cleaveland/Price Inc., Bulletin DB-600A12. Such a phase over phase unitized switch assembly when fully assembled is desirably shipped by truck to its final location for installation in an electric utility system.

The same wide width problem may arise with such elongated single base member type unitized switch assemblies as disclosed in said U.S. Pat. No. 9,355,797 B1 and in said Cleaveland/Price Inc. Bulletin DB-600A12. These switch assemblies may include two-way and three-way in addition to the said one-way unitized phase over phase switch arrangements. Depending on the voltage rating of the switches, these assemblies as mentioned are often too wide to ship legally by tractor trailer type trucks on U.S. roads. Specifically, for example, a three-way 138 kV switch assembly which is attached to an elongated single base member in the final assembled state is oversized and too wide to ship legally by truck in the U.S.

U.S. Pat. No. 10,128,067 B1 issued to Charles M. Cleaveland, on Nov. 13, 2018, and assigned to present assignee Cleaveland/Price Inc., discloses a three phase unitized high voltage disconnect switch assembly with a cantilevered telescoping base which solves the wide width shipment problem. The invention disclosed in said U.S. Pat. No. 10,128,067 B1 is directed to a three phase unitized high voltage disconnect switch assembly that uses a single elongated base member with attached transverse members carrying the pole units. The transverse members are provided with a telescopic capability so that the width of the three phase unitized high voltage switch assembly can be reduced to a legal width, such as 102 inches or less, for legal shipment by truck in the U.S. without a wide load permit. The said U.S. Pat. No. 10,128,067 B1 is also herein incorporated by reference as though fully set forth.

Reference is also made to U.S. Pat. No. 8,541,702 B2 issued to Frank Clay Blalock, on Sep. 24, 2013, and assigned to Southern States, LLC of Hampton, Ga., which discloses a single phase non-unitized high voltage electric power switch that includes a triangular platform in the operative position with three phase insulators mounted at each corner of the triangular platform and a fourth central insulator mounted centrally to the three phase insulators. The Blalock platform includes a central beam supporting the central insulator and one phase insulator. Two lateral beams connected to a fulcrum connected to the central beam each carry one of the other phase insulators. The Blalock platform also includes two split struts each having an upper rail and a lower rail that receive therebetween one of the lateral beams during a folding of the switch to ship the switch and the split struts and the lateral beams unfold for installation of the switch. Unlike the Blalock platform the present invention is directed to a three phase assembly, including three single blade switches, for example, with each switch mounted on a straight rigid pole unit beam. Each switch has insulators which are only mounted longitudinally in a row on the respective straight rigid beam. The switch assembly of the present invention has a single mounting platform for the three pole unit beams. The single mounting platform of the present invention includes a width reduction provision, as described subsequently, where the longitudinally mounted insulators of each pole unit beam remain in a fixed position relative to one another during any width reduction operation, unlike the insulators of the Blalock platform.

It is therefore an object of the present invention to devise an improved unitized gang-operated three phase high voltage switch assembly having a rectangular switch frame common base, comprising a plurality of high voltage disconnect switch pole units each mounted to rigid linear short parallel transverse members mounted on two parallel long longitudinal beams of the rectangular disconnect switch frame common base and including associated phase to phase gang-operated linkage between the three poles, where the whole assembly including the rectangular frame common base can easily be reduced in width for legal shipment by truck in the U.S. without a wide load permit, and then can easily have the common base width expanded upon arrival at the job site for final installation without substantial disassembly of the switch assembly.

### SUMMARY OF THE INVENTION

The lower voltage prior art unitized gang-operated three phase high voltage air break disconnect switch assembly with a rectangular switch frame common base structural platform, such as disclosed in the previously mentioned Cleaveland/Price Inc. Bulletin DB-680A15, entitled “Unitized ‘Quick Install’ Switches for Substation Applications” may include, for example, three single phase vertical break, center break or side break high voltage disconnect switch pole units, one for each phase, successively mounted on the rectangular disconnect switch frame common base for substation or transmission switch application. Each of the switches may be arranged in a one-way switch arrangement, for example. The individual switch pole units depending on the switch type may have one or two electrically conductive blades. Vertical break, double break and side break switches have one electrically conductive blade. Center break switches have two electrically conductive blades. The transverse switch support members are immovably attached to underlying parallel oppositely disposed longitudinal relatively longer support beams by bolts or welding to form the rectangular switch frame common base rectangular outer perimeter. After shipment the prior art unitized gang-operated three phase high voltage air break disconnect switch assembly is installed at the job site by mounting it to a utility pole or the like, so that the rectangular disconnect switch frame common base in the final installed position can have a vertical orientation for a transmission application or a horizontal orientation when the rectangular switch frame common base is attached to the legs of a substation structure, for example.

The present invention solves the problem of oversized rectangular base unitized switch arrangements being too wide to ship legally by trailer truck on U.S. public roads without a special governmental permit. The present invention provides such unitized switch arrangements with a power actuated transformable parallelogram outer perimeter common base which provides for one of the long longitudinal parallel beams to remain stationary while the other long longitudinal parallel beam can be moved in a translating manner parallel with respect to the stationary longitudinal beam, by sliding it parallel to the stationary beam to reduce the width of the parallelogram outer perimeter common base, which in one embodiment, the translation may be accomplished by the use of a winch powered transformable common base. The transformable parallelogram outer perimeter switch frame common base configuration by use of pivot connections, i.e., hinges or hinge sections working in unison, may be easily transformed from the rectangular prior art configuration, i.e., when viewed from above the common base, to a rhomboid configuration by translating of a sliding parallel beam for transport by trailer truck or vice versa. The transformation of the switch assembly from the rhomboid configuration to the rectangular configuration with the final installation width, for installation at the job site, may easily be accomplished by use of a powered winch, attached in predetermined position to the common base, or by use of an equivalent power actuator, such as hydraulic or leadscrew actuated systems, not shown in the drawings. At the jobsite, the switch assembly can be unloaded from the truck by crane and placed on timbers on the ground. The power winch can then slide the rhomboid configuration back to the rectangular configuration ready for final bolting and re-lifting to its intended location. The transformable common base of the present invention while in the rhomboid configuration provides the requisite reduced width, roughly matching the width of a truck trailer, but not exceeding 102 inches, for fitting on a truck trailer for normal shipment to a job site while maintaining maximum load stability.

The transformable common base of the present invention constantly retains an outer perimeter having the parallelogram configuration, which can be varied, i.e., transformed, from a rectangular to a rhomboid configuration and back again. At a minimum, four members of the common base, i.e., the two long parallel longitudinal beams and the two short parallel outer transverse beams are physically connected to form the outer perimeter in a parallelogram arrangement with reference to the previously mentioned horizontal plane before, during and after any switch assembly transformation. The mounted insulators of each individual switch pole unit remain in a fixed position on the respective rigid linear parallel transverse beam relative to one another during any width reduction operation before, during and after transformation of the common base. This helps to ensure that the individual switch pole units are not disturbed from their factory settings during translation of the longitudinal parallel beams and are ready for proper operation of the unitized three phase switch after being installed at the job-site.

The transformation of the unitized switch common base to the narrower rhomboid shape in one embodiment of the invention is accomplished, as mentioned, by a single pulling on one translating longitudinal long beam relative to the other stationary longitudinal long beam by the winch, or an equivalent power actuator, after all common base mounting bolts of each hinge or hinge section have been removed except for a particular one. The remaining bolt in each hinge functions as a hinge bolt having a longitudinal axis that permits the translation of the one long beam by sliding parallel relative to the other stationary long beam to reduce the width of the switch frame common base.

In one embodiment specifically designed are inner mounting clips with large holes preferably included for engaging a winch, such as, a “come-along” actuator ratchet winch to therefore easily identify the attachment point of the “come-along” actuator winch for transforming the common base to the standard rectangular shape at the final assembly point at the job site. This ability to transform the switch frame common base configuration in one pulling effort is made possible by providing a two position hinge, at the juncture at the end of each transverse beam member with a respective longitudinal beam.

A method for accomplishing the transformation of the three phase unitized gang-operated switch of the present invention is also disclosed.

These and other aspects of the present invention will be further understood from the detailed description of the particular embodiments, drawings and claims, using a vertical break type switch as an example, but this invention can be applied also to other types of switches such as side break, center break and double break switches.

### BRIEF DESCRIPTION OF THE DRAWINGS

FIG. 1 is a perspective view of a three phase unitized gang-operated high voltage switch assembly of the present invention with box-like hollow longitudinal beams in a one-way switch configuration for each phase, with a vertical break high voltage disconnect switch pole unit mounted in each phase, with a transformable switch assembly base structure shown in the rectangular fully extended final installation position;

FIG. 2 is a schematic plan view of the base arrangement shown in FIG. 1;

FIG. 3 is a partial enlargement from a circled area of FIG. 2 plan view;

FIG. 4 is a schematic end view taken along ‘4’-‘4’ of FIG. 2;

FIG. 5 is a partial enlarged top view of FIG. 2 without switch and hat shaped bracket at an end of a box-like longitudinal beam showing the unique pattern of holes in the top face of the side-attached transverse beam mounting brackets;

FIG. 6 is the same as FIG. 1 but the three phase unitized high voltage switch assembly is shown with the transformable switch assembly base structure in the narrower rhomboid position for shipment by truck;

FIG. 7 is a schematic plan view of the base arrangement shown in FIG. 6;

FIG. 8 is a partial enlarged perspective view taken along line ‘8’-‘8’ of FIG. 6;

FIG. 9 is a partial enlarged perspective view taken along the line ‘9’-‘9’ of FIG. 1 with an attached winch;

FIG. 10 is a partial enlarged perspective view taken along the line ‘10’-‘10’ of FIG. 6 showing details of the pivot connection, i.e., hinge in the narrower position with attached “come-along” actuator;

FIG. 11 is the same as FIG. 9, but with wide flanged longitudinal beams instead of box-like longitudinal beams;

FIG. 12 is the same as FIG. 10 but with wide flanged longitudinal beams instead of box-like hollow longitudinal beams;

FIG. 13 is a partial enlarged perspective view taken along the line of ‘13’-‘13’ of FIG. 11;

FIG. 14 is a perspective view of a prior art three phase unitized gang-operated high voltage switch assembly with box-like hollow longitudinal beams in a one-way switch configuration for each phase, with a vertical break high voltage disconnect switch pole unit mounted in each phase, with a rectangular common base configuration; and,

FIG. 15 is an enlarged perspective view indicated by a circled area in FIG. 14 showing a portion of the prior art switch assembly.

### DETAILED DESCRIPTION OF THE PARTICULAR EMBODIMENTS

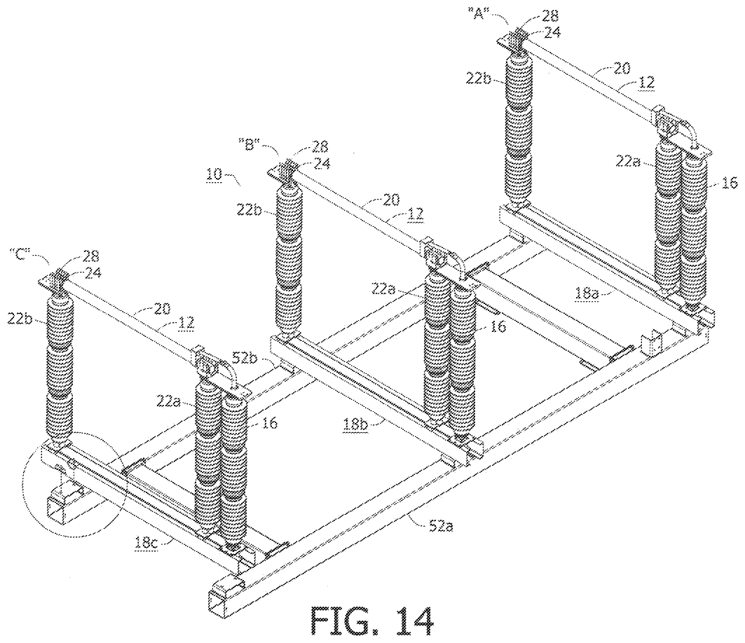

With reference to FIG. 14, a prior art three phase unitized gang-operated high voltage switch assembly 10 is shown with two parallel box-like hollow longitudinal beams 52a, 52b of equal length. The switch assembly 10 includes a one-way switch configuration for each phase, with a vertical break high voltage disconnect switch pole unit 12 mounted in each phase, “A”, “B”, and “C”. The prior art switch assembly 10 has a rectangular common base configuration as shown. Rigid linear parallel transverse switch support members 18a, 18b, and 18c are attached to the box-like hollow longitudinal beams 52a, 52b in a permanent installation position. Each switch pole unit 12 is mounted on one of the transverse switch support members 18a, 18b, or 18c. Each switch pole unit includes a rotating insulator 16, and stationary insulators 22a, 22b and at least one switch blade 20. The switch blade 20 is mounted in operative position, with its distal end 24 engaging female contact 28 when the switch pole unit 12 is in the closed electrically conductive position. As can be surmised from viewing FIG. 14, the prior art switch assembly 12 cannot be reduced in width after factory assembly.

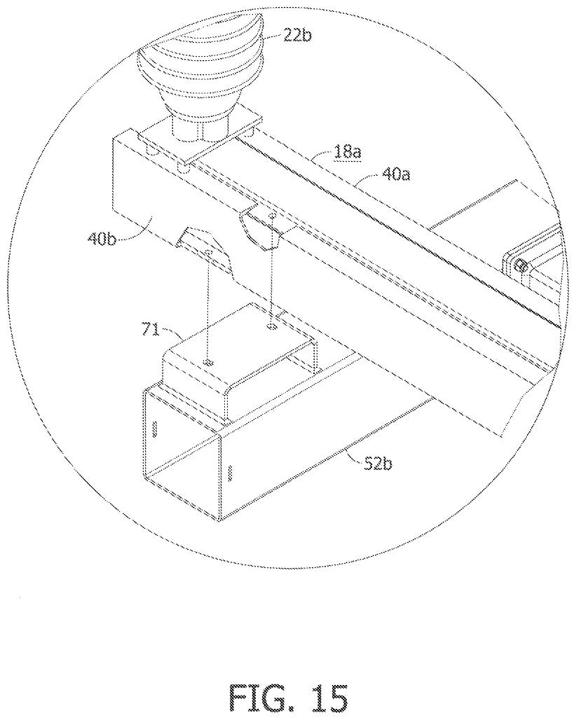

With reference to FIG. 15, it can be seen that the transverse switch support members 18a, 18b and 18c are each comprised of respectively flanged U-shaped channel beams 40a, 40b which are attachable at the ends of the respective transverse members to U-shaped bracket 71, which is welded to the respective longitudinal beam 52b, for example, which of course does not allow the transformation described in the present invention.

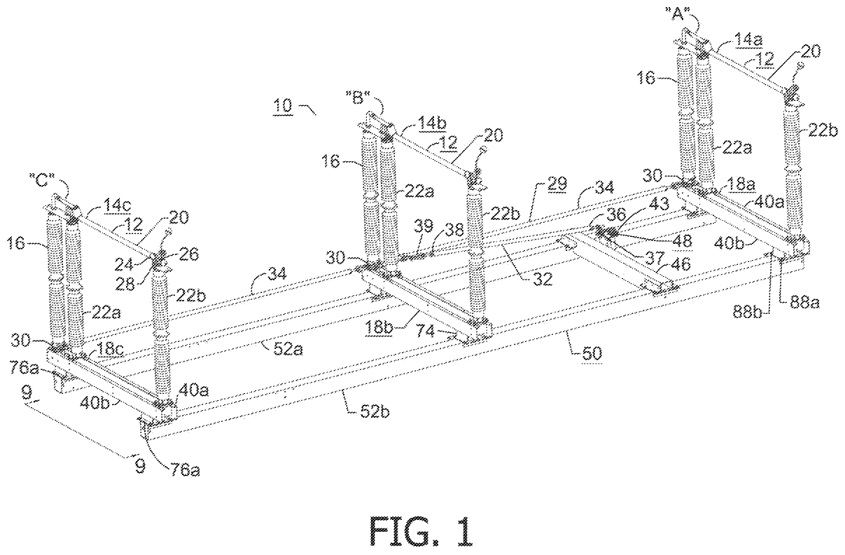

With reference to FIG. 1, there is shown a perspective view of a three phase unitized gang-operated high voltage switch assembly 10 of the present invention in a one-way switch configuration with three switch pole units 14a, 14b, 14c, each arranged in one of the electrical phases ‘A’, ‘B’, ‘C’. Each switch pole unit 14a, 14b, and 14c as shown in FIG. 1 comprises a single vertical air break high voltage disconnect switch pole unit 12, for example, with the switch assembly shown in a final installed configuration. Each vertical break switch pole unit 12 is shown in the fully closed position. The switch assembly 10 is adapted to be compatible with a three phase alternating current electrical power system which includes the phase ‘A’, an intermediate phase ‘B’ and phase ‘C’. For further details of such vertical air break switches from 115 kV to 230 kV, reference may be made to Bulletin DB-A06BH09, entitled “Type V2-CA Aluminum Vertical Break Switch” by Cleaveland/Price Inc, the present assignee. As mentioned instead of vertical air break disconnect switches, the present invention is also applicable to center break, double break or side break high voltage disconnect switches, for example.

Each switch pole unit 14a, 14b, and 14c of the vertical break switch assembly 10 shown in FIG. 1 includes a rotating insulator 16 which is mounted respectively on rigid linear transverse switch support members 18a, 18b, and 18c. The rotating insulators 16, upon rotation cause the vertical break high voltage switch pole units 12 to either open or close. Each vertical break high voltage switch pole unit 12 includes an electrically conductive switch blade 20, as is well known in the art.

Each switch pole unit 14a, 14b, 14c for a vertical break switch also includes a pair of stationary insulators 22a, 22b. Each switch blade 20 at its distal end 24 has a male contact 26 that engages a female contact 28 carried on stationary insulator 22b. When the vertical break switch 12 is closed the male contact 26 engages the female contact 28 for current flow.

The rotating insulators 16 are rotated by interphase gang-operated drive linkage 29 imparting motion to drive lever 30 of each switch pole unit 14a, 14b, and 14c. The interphase gang-operated linkage 29 includes a drive rod 32 imparting motion to interphase rods 34, as is well known in the art, resulting in the synchronized operation of the switch assembly 10. The drive rod 32 is connected at one end 36 to a first lever arm drive mechanism 48, including outboard bearing lever 37 and an outboard bearing 43 and at the other end 38 to a clevis 39 that is connected to interphase rod 34, as shown in FIG. 1.

An interphase drive linkage drive mechanism supporting transverse beam 46 may carry the first lever arm drive mechanism 48, including the outboard bearing 43 and outboard bearing lever 37. The drive mechanism supporting transverse beam 46 may be a box beam such as shown in FIG. 1, for example. The interphase gang-operated drive linkage 29 may be easily disconnected from each switch pole unit 14a, 14b, and 14c, if necessary, to accommodate the transformation of the unitized rectangular common base.

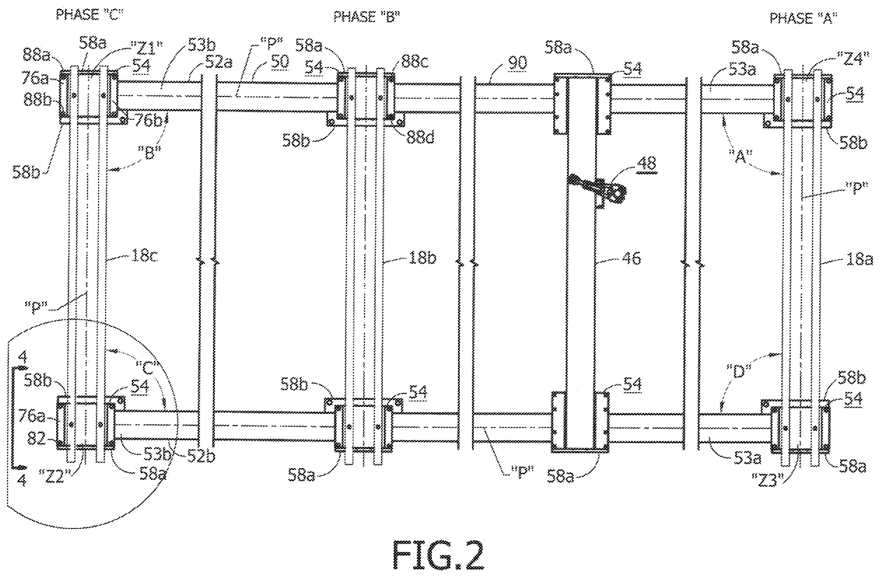

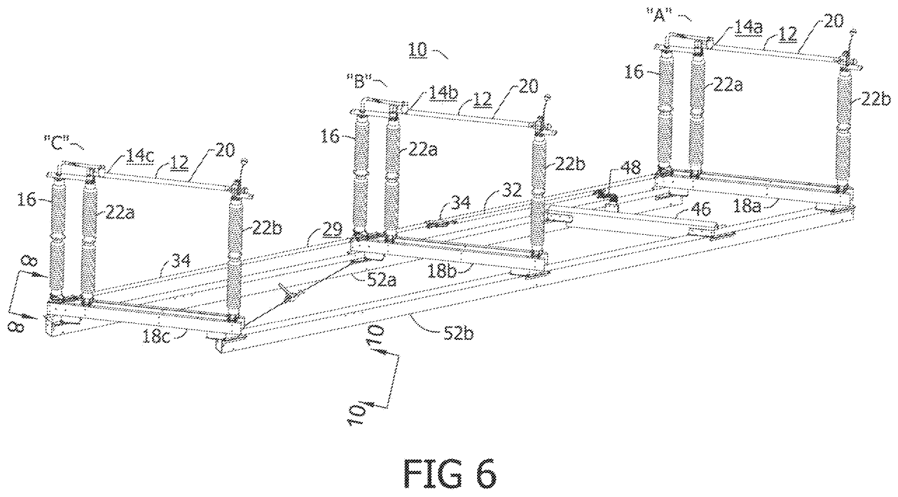

As shown in FIG. 2, the pivot connections, i.e., hinges 54 allow the three phase switch assembly to be transformed to the reduced width rhomboidal configuration shown in FIG. 6. In the present embodiment, longitudinal beams 52a, 52b are box-like hollow longitudinal beams. Each hinge 54 includes side-attached transverse beam mounting brackets 58a, 58b attached to opposite sides of the respective box-like hollow longitudinal beams 52a, 52b at the ends 53a, 53b thereof.

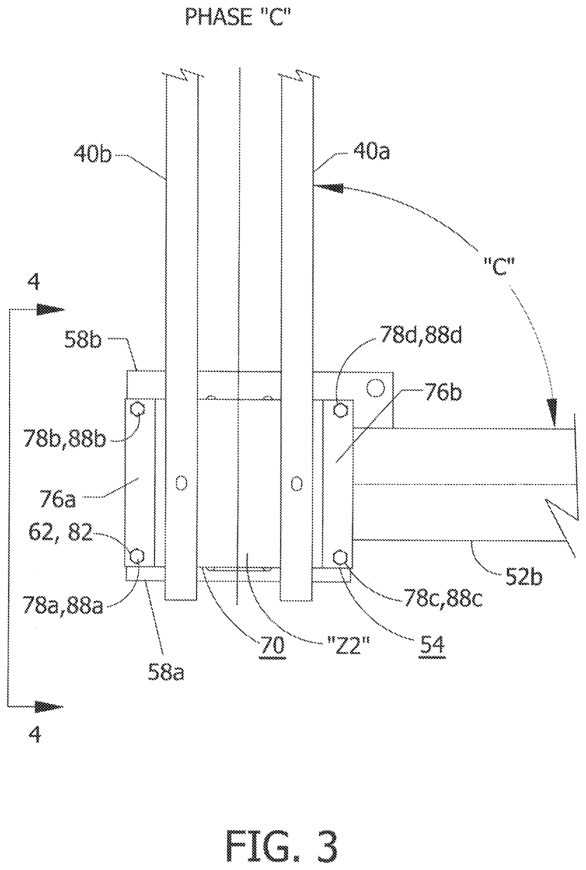

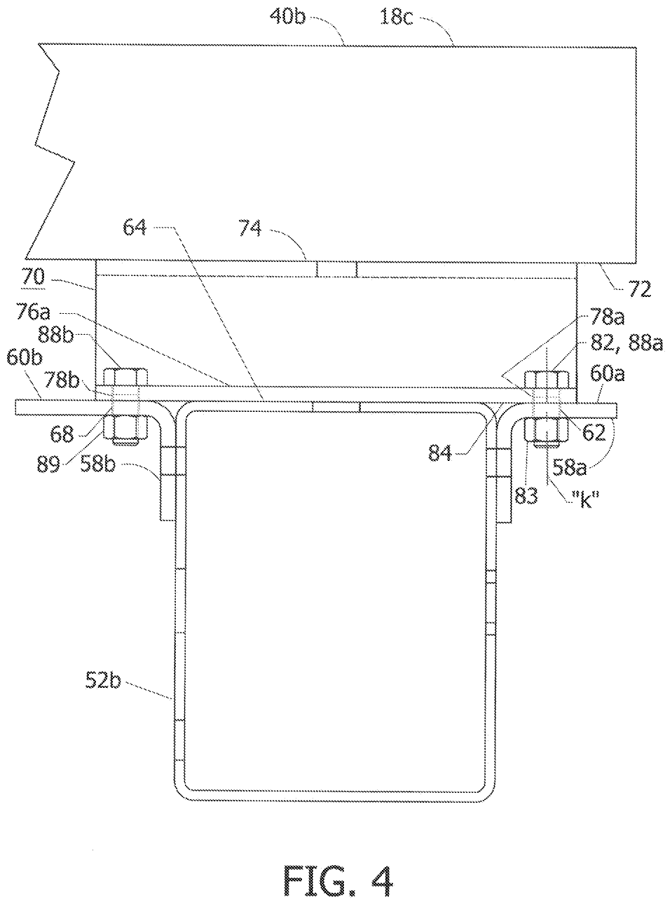

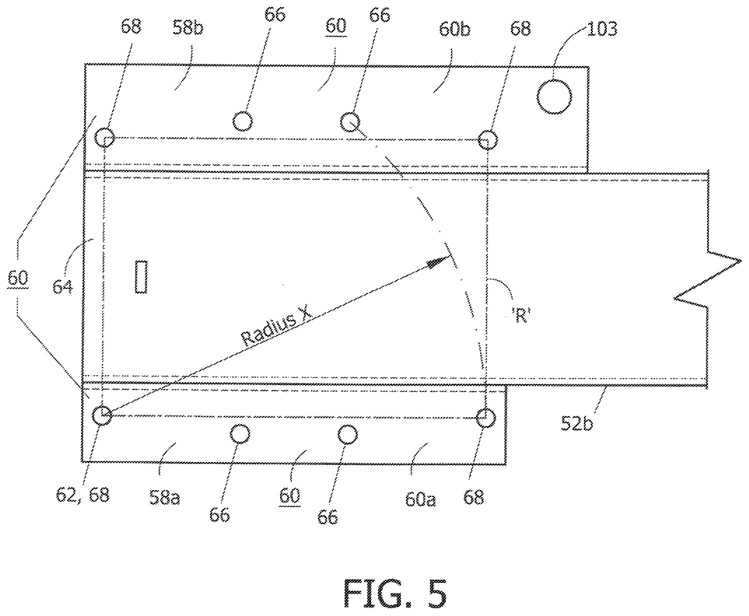

Each hinge 54, for the box-like hollow longitudinal beam embodiment, also includes a hat-shaped bracket 70 as shown in FIG. 4, which is attached to opposites ends of each rigid transverse switch support member 18a, 18b, and 18c at the bottom 72 thereof. The hat-shaped bracket 70 when viewed from the side has a central raised section 74 which is arranged between two integral opposite flange members 76a, 76b as shown in FIG. 3. Hat-shaped bracket flange member 76a is provided with a first pair of flange member holes 78a and 78b for receiving securement bolts 88a and 88b. Hat-shaped bracket flange member 76b is provided with a second pair of flange member holes 78c and 78d for receiving securement bolts 88c and 88d. The arrangement of the four flange member holes 78a, 78b, 78c and 78d results in an upper hole pattern of the hinge 54 which is rectangular, with each of the four flange member holes occupying one of the corners of the rectangle. The four holes 78a, 78b, 78c and 78d are in operative alignment with the certain holes of the combined top face 60, i.e., holes 68 when the common base is in the rectangular configuration CR′ as shown on FIG. 5.

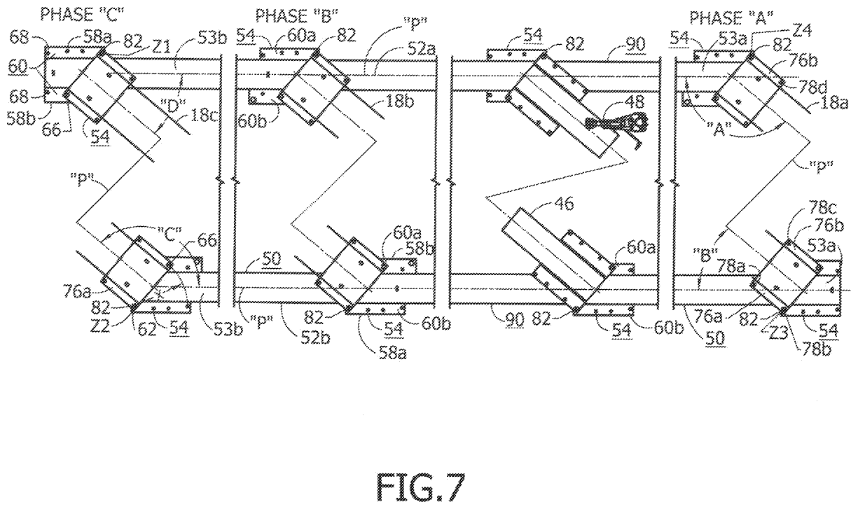

With reference to FIGS. 3, 4 and 5, for example, one of the flange member holes 78a of one of the hat-shaped bracket flange members 76a can function as an upper hinge bolt receiving hole, which in the operative position, aligns with a corresponding lower hinge bolt receiving hole, i.e., the first hinge bolt receiving hole 62, in the combined top face 60 of the side-attached transverse beam mounting brackets 58a, 58b of longitudinal beam 52b. A hinge bolt 82 passes through both the upper hinge bolt receiving hole 78a and lower hinge bolt receiving hole 62. The longitudinal axis of the hinge bolt 82 operates as a hinge axis “k” as shown in FIG. 4 to permit the already described translation or shift movement of the common base 50. Hinge bolts 82 are located at the four corners “Z1”, “Z2”, “Z3”, and “Z4” of the variable, i.e., transformable, parallelogram 90 formed by the outer perimeter “P” of the common base 50. Hinge bolts 82 are also included in the hinges 54 of the center transverse beam 18b and the linkage drive mechanism support transverse beam 46, as shown in FIG. 7.

The hinge bolts 82 when installed in each hinge 54 remain at all times connected to the two longitudinal beams 52a, 52b and the respective rigid transverse switch support members 18a, 18b, and 18c and the drive mechanism transverse beam 46 as shown in FIG. 7 while still permitting translation of the common base 50 from the rectangular configuration shown in FIG. 1 to the reduced width rhomboid configuration as shown in FIG. 6 for shipping. The hinge bolts 82 permit translation of the common base 50 from the rhomboid shipment configuration back to the rectangular configuration for permanent installation at the job site, but prevent the longitudinal beams 52a, 52b from becoming separated from the transverse beams 18a, 18b, 18c and 46 of the unitized switch assembly 10, which provides for ease in transformation of the common base 50 and integrity of the switch assembly 10 structure.

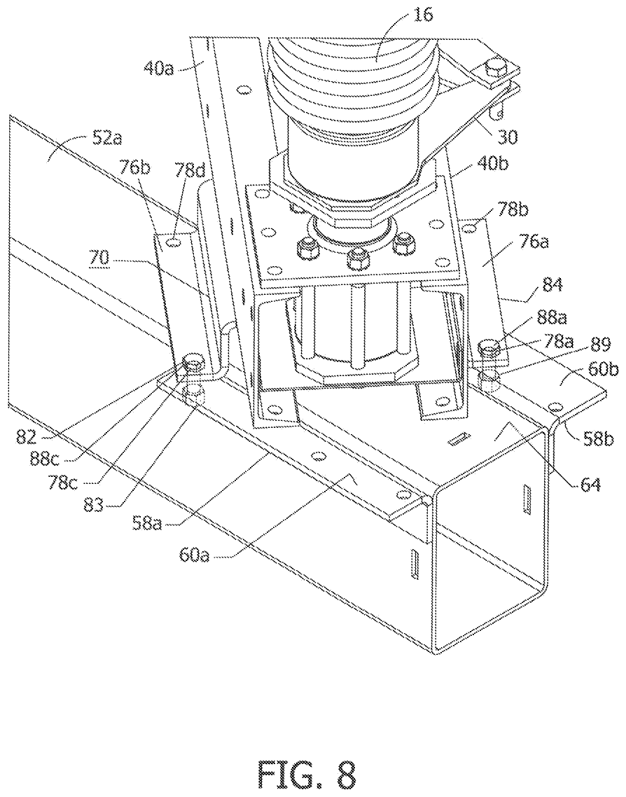

As shown in FIGS. 4 and 8, the bottom surface 84 of each flange member 76a, 76b of the hat-shaped bracket 70 is preferably in a slidable low friction contact with the top surface 64 of the box-like hollow longitudinal beams 52a, 52b, as well as with the combined top face 60, i.e., the top face portions 60a, 60b of the side-attached transverse beam mounting brackets 58a, 58b—so no edge can catch. The securement bolts 88a, 88b, 88c, 88d, one of which, as mentioned, is also the hinge bolt 82, engage one or more of the holes 62, 66, and 68 in the top face 60 depending on whether the common base 50 is in the rectangular or rhomboid configuration.

One of the flange member holes 78a, 78b of one of the flange members 76a, 76b, as mentioned, can operate as an upper shipment engagement hole for receiving a securement bolt 88a, 88b, 88c, or 88d which in conjunction with the hinge bolt 82 locks the switch assembly in place in the reduced width rhomboid configuration for shipping with the common base 50 upon these bolts engaging the appropriate hole in the top face 60.

The top face 60 is preferably provided with four shipment securement holes 66, as shown in FIG. 5, so that the flange members 58a, 58b may be used on various hinges 54 of the switch assembly 10 to reduce costs. As can be seen by the dashed line in FIG. 5, the shipment securing holes 66 are offset outside of the imaginary perimeter of the rectangle ‘R’. Only one of the four shipment securement holes of the top face 60 is used for a single hinge 54 depending on which of the corners “Z1”, “Z2”, “Z3”, or “Z4” of the common base 50 the hinge is located. Referring to FIG. 5 for example, the one securement hole 66 that is used for corner “Z2’ is located from the hinge bolt receiving hole 62 as follows: the end of an imaginary line acting as “Radius X” and equal in length to the distance between the center of hole 68 and center of the respective lower hinge bolt receiving hole 62 located in the same top face portion 60a is rotated in a circle about the center of hole 62 through an angular distance of 50 degrees to locate the center of the one securement hole 66. This results in the corresponding attached rigid transverse switch support members 18a, 18b, 18c being at the desired angle with respect to the longitudinal beams 52a, 52b in the rhomboid configuration, such as with angles “A” and “C” being 140 degrees and angles “B” and “D” being 40 degrees, as shown in FIG. 7. For a switch of 230 kV with longitudinal beams 52a, 52b having a length of 32 feet and transverse support members 18a, 18b, 18c having a 132 inch length, using the hinges 54 of the present invention results in a reduced width in the rhomboid configuration of 100 inches for standard shipping on a truck trailer.

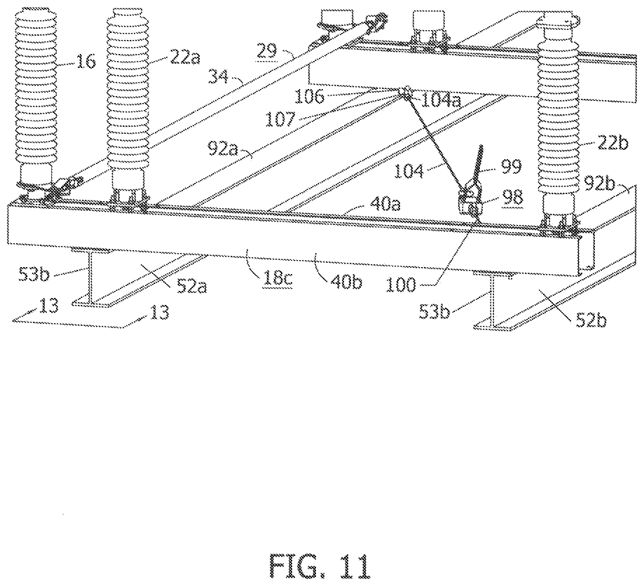

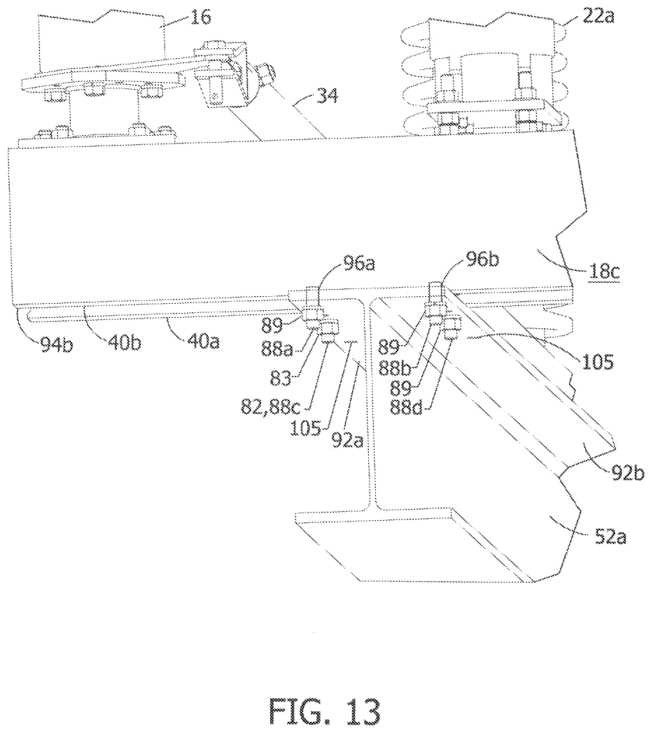

In a second embodiment of the invention, instead of using box-like hollow longitudinal beams, two wide flanged beams in the form of I-beams may be used, as shown in FIG. 11. Each wide flanged longitudinal beam 52a, 52b should have at least an 8 inch wide top flange, for example. Each wide flange longitudinal beam 52a, 52b at the ends 53a, 53b thereof include in the opposite top flanges 92a, 92b of each beam 52a, 52b an equivalent pattern of holes of the combined top face 60, as described for the top face portions 60a, 60b for the box-like hollow longitudinal beam. As shown in FIGS. 11, 12 and 13, each wide flange longitudinal beam 52a, 52b is provided with additional patterns of holes, similar to that described for the combined top face 60, in the center of the beam for receiving the transverse switch support member 18c and where the drive mechanism supporting transverse beam 46 is located, similar to that shown in FIG. 1.

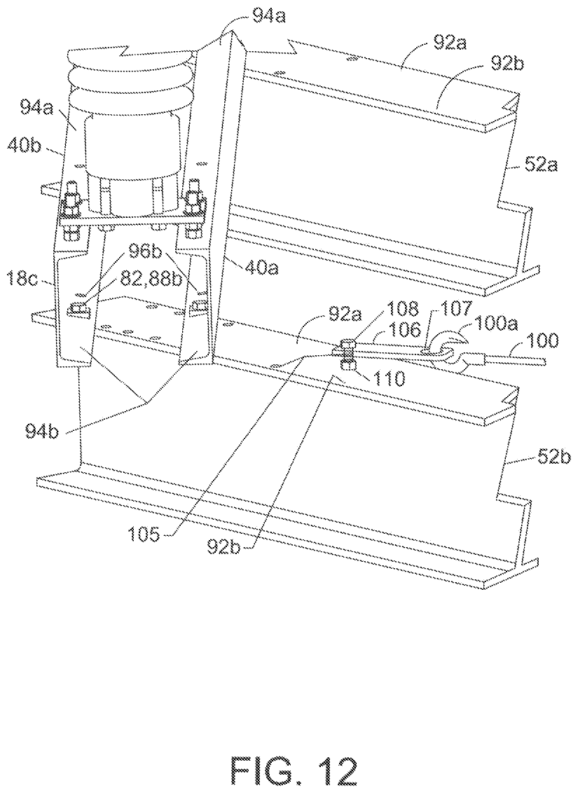

In this second embodiment of the invention the hat-shaped transverse beam mounting brackets 70 are not needed. The rigid transverse switch support members 18a, 18b, and 18c may also comprise a pair of flanged U-shaped channel transverse switch support members 40a, 40b, as described for the first embodiment. Each flanged U-shaped channel transverse switch support member 40a, 40b includes an upper flange portion 94a and a lower flange portion 94b extending perpendicularly from the channel-like support members 40a, 40b as shown in FIGS. 11 and 12. Two flange securement holes 96a, 96b are provided at the ends of each of the flanged transverse switch support members 40a, 40b in the lower flange portion 94b, for example. The flange securement holes 96a, 96b have a hole arrangement as described for each of the flange members 76a, 76b of the hat-shaped bracket 70.

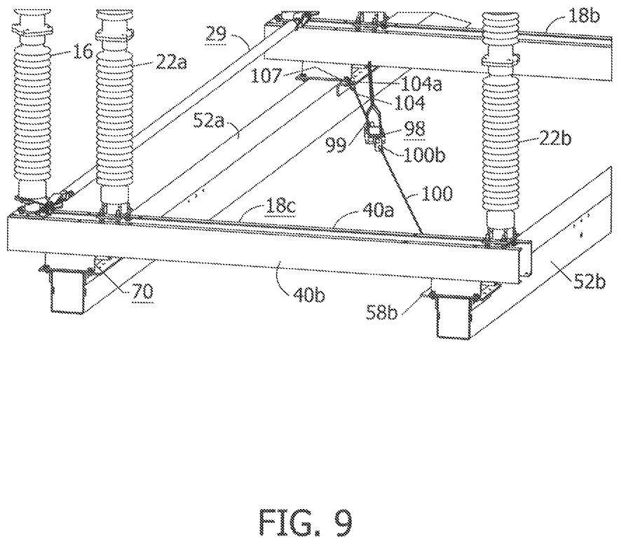

As shown in FIG. 9 the transformation of the outer perimeter “P” of the common base 50 to the narrower rhomboid shape can be accomplished by a single pulling on one longitudinal beam 52a, relative to the other longitudinal beam 52b by a winch 98, or an equivalent power actuator, after all the common base mounting bolts 88a, 88b, 88c, and/or 88d of each hinge except for the hinge bolts 82 have been removed.

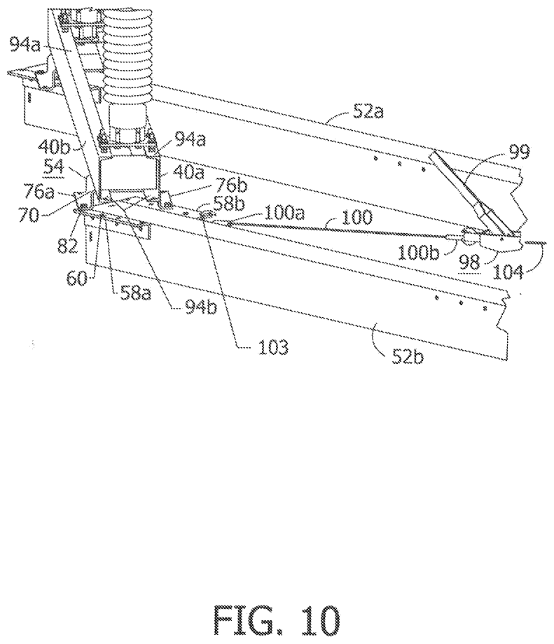

The winch 98 may be a “come-along” actuator, as shown in FIGS. 9 and 10, which includes a first hooked cable 100 having a first hook 100a and a second hook 100b. The “come-along” actuator 98 includes a handle-ratchet 99, as is well known in the art. In FIG. 10, the first hook 100a engages a large hole 103 in the side attached beam mounting bracket 58b, for the box-like hollow longitudinal beams 52a, 52b embodiment, or as shown in FIG. 12, a hook engagement bracket, i.e., flat bar member 106 with a similar large hole 107 is retained by mounting bolt 108 passing through hook engagement bracket mounting hole 105 and engaging nut 110 to the upper flange of the wide flange beam embodiment. The second hook 100b engages the handle-ratchet 99 as shown in FIG. 10. A second cable 104 is wrapped at one end on a drum in the handle-ratchet 99, not shown in the drawings. The second cable 104 is provided with a hook 104a at the other end for engaging another flat bar member 106 with a large hole 107 as shown in FIG. 11.

The method for accomplishing the transformation of the switch assembly 10 is now described. At the factory the three phase unitized gang-operated high voltage switch assembly 10 is assembled and adjusted for proper three phase operation and then transformed into the rhomboid configuration for shipment. In the rhomboid configuration the hinges are placed in the second position, using only two of the four securement bolts. One of the shipment securement bolts of each hinge 54 functions as the hinge bolt 82. The hinge bolts are arranged as shown in FIG. 7. The remaining shipment securement bolt of each hinge engages the respective shipment securement hole 66. Hinge bolt nuts 83 are placed on each hinge bolt 82 and securement nuts 89 are placed on each remaining shipment securement bolt 88a, 88b, 88c, 88d to lock the respective bolts in place, as partially shown in FIG. 4. The assembled switch assembly 10 in the rhomboid configuration is loaded on a tractor trailer and the switch assembly is shipped to the job site. At the job site, the switch assembly 10 is unloaded from the trailer. The securement bolts 88a, 88b, 88c, 88d of each hinge 54 are removed except for hinge bolt 82. The hinge bolt nut 83 engaging each hinge bolt 82 of each hinge 54 is loosened to permit hinge movement. The winch 98 is installed on the common assembly 50 as already described. A workman cranks handle-ratchet 99 for moving simultaneously each hinge 54 to permit the common base 50 to be transformed from the rhomboid configuration to the rectangular configuration for permanent installation, by placing each hinge in the first position, as shown in FIG. 2. Once in the proper rectangular configuration each hinge bolt nut 83 engaging each hinge bolt 82 is tightened and three additional securement bolts of 88a, 88b, 88c, 88d are inserted into each hinge 54 and nuts placed on them to lock the common base 50 in the final rectangular configuration. The switch assembly 10 is then installed into final position at the job site.

Of course variations from the foregoing embodiments are possible without departing from the scope of the invention.

What is claimed is:

1. A three phase gang-operated high voltage electric disconnect switch assembly comprising:
a gang-operated switching unit per each electrical phase, each of the gang-operated switching units including at least one high voltage electric disconnect switch including a plurality of high voltage electrical insulators, each gang-operated switching unit mounted in operative arrangement on a linear transverse switch support member, each linear transverse switch support member mounted transversely on a pair of oppositely disposed parallel beams, each parallel beam having a top surface having secured thereto in spaced arrangement a plurality of the linear transverse switch support members with one linear transverse switch support member per electrical phase,
a drive linkage transverse support member mounted transversely on the pair of oppositely disposed parallel beams,
each of said linear transverse switch support members configured to support in operative arrangement the plurality of high voltage electrical insulators of the respective gang-operated switching unit, at least one of said high voltage electrical insulators of each of said linear transverse switch support members adapted to be rotatable,
two of the linear transverse switch support members configured as outer transverse switch support members in operative attachment proximate their ends to respective opposite ends of the pair of oppositely disposed parallel beams and configured to form a unitized rectangular common base,
the unitized rectangular common base configured to have in a first rectangular configuration a fixed multiple bolt connection between the ends of each of the linear transverse switch support members and the pair of oppositely disposed parallel beams and a fixed multiple bolt connection between the ends of the drive linkage transverse support member and the pair of oppositely disposed parallel beams and configured to have in a second rhomboidal configuration a pivot connection between the ends of each of the respective linear transverse switch support members and the pair of oppositely disposed parallel beams and a pivot connection between the ends of the drive linkage transverse support member and the pair of oppositely disposed parallel beams by removal of all the fixed bolts except one retained bolt at each pivot connection,
a removable power actuator configured to pull and transform the unitized rectangular common base to a rhomboidal shape in the second rhomboidal configuration to reduce the width of unitized rectangular common base to a predetermined width to allow shipment of the three phase gang-operated high voltage electric disconnect switch assembly on a truck to an electric utility.

2. The three phase gang-operated high voltage electric disconnect switch assembly of claim 1, wherein the removable power actuator is configured to pull and transform the unitized rectangular common base that is in the second rhomboidal configuration back to the first rectangular configuration and wherein the removed fixed bolts are reinstalled at each pivot connection to form the fixed multiple bolt connection to maintain a rectangular shape in the first rectangular configuration for the unitized rectangular common base for final installation on an electric utility system.

3. The three phase gang-operated high voltage electric disconnect switch assembly of claim 1, wherein the pair of oppositely disposed parallel beams are tubular.

4. The three phase gang-operated high voltage electric disconnect switch assembly of claim 1, wherein the pair of oppositely disposed parallel beams are structural I-beams.

5. The three phase gang-operated high voltage electric disconnect switch assembly of claim 1, further comprising power actuator attachment points configured to provide for the removable power actuator connection for the width reduction transformation of the unitized rectangular common base and configured to provide for the removable power actuator connection for a reversal of the width reduction of the unitized rectangular common base.

6. The three phase gang-operated high voltage electric disconnect switch assembly of claim 1, wherein the removable power actuator is a cable ratchet winch of the “come-along” actuator type, or a hydraulic cylinder actuator.

7. The three phase gang-operated high voltage electric disconnect switch assembly of claim 1, further comprising a phase-to-phase gang-operated drive linkage in operative connection with each of the gang-operated switching units in the first rectangular configuration of the unitized rectangular common base, the phase-to-phase gang operated drive linkage configured to accommodate the transformation of the unitized rectangular common base.

8. The three phase gang-operated high voltage electric disconnect switch assembly of claim 1, wherein the unitized rectangular common base in the second rhomboidal configuration each of the pivot connections further includes a shipment securement hole configured to receive a shipment securement bolt for locking the unitized rectangular common base to secure the unitized rectangular common base for shipment.

9. A method for operating the three phase gang-operated high voltage electric disconnect switch assembly of claim 8, comprising the following steps:
assembling and adjusting the switch assembly for proper three phase operation in the unitized rectangular common base configuration,
transforming the unitized rectangular common base to the second rhomboidal configuration for shipment to a job site by removing all of the fixed bolts except the one retained bolt at each of the pivot connections and then installing a shipment securement bolt at each the pivot connections,
removing all the securement bolts at the job site and operatively connecting the removable power actuator to the unitized rectangular common base so that a workman can operate the removable power actuator to transform the unitized rectangular common base from the reduced width rhomboidal shape in the second rhomboidal configuration to the first rectangular configuration with maximum width rectangular shape for installation at a job site,
reinstalling in operative arrangement the removed fixed bolts for final installation at the job site.
